(19) United States
(12) Patent Application Publication
(10) Pub. No.: US 2021/0087869 A1
(43) Pub. Date: Mar. 25, 2021

(54) Method and Device for the Non-Mechanical Activation of a Closure Arrangement

(71) Applicant: Bayerische Motoren Werke Aktiengesellschaft, Muenchen (DE)

(72) Inventors: Horst DIETEWICH, Reichertshausen (DE); Matthias FINDEIS, Geltendorf (DE); Christoph LAMPL, Muenchen (DE); Pia MONDAL, Kochel am See (DE); Niklas SCHWELLENBACH, Neufahrn (DE); Daniel STIGLBAUER, Mainburg (DE)

(21) Appl. No.: 17/054,325

(22) PCT Filed: May 28, 2019
(86) PCT No.: PCT/EP2019/063738

§ 371 Date: Nov. 10, 2020

(30) Foreign Application Priority Data
Jun. 11, 2018 (DE) 10 2018 209 256.7

(51) Int. Cl. E05F 15/70; E05F 15/60; G06N 20/00

(52) U.S. Cl. CPC E05F 15/70; G06N 20/00; E05F 15/60

(57) ABSTRACT

A method and a device are provided for non-mechanical activation of a closure arrangement, in particular of a vehicle door, by way of a mobile terminal. The mobile terminal is registered and corresponding registration information is generated, on the basis of which an activation signal is transmitted to the registered terminal. The terminal changes from a first operating state into a second operating state on the basis of the activation signal, wherein in the second operating state a user input is registered by way of the terminal, and corresponding input data are generated. An activation signal which is output by the terminal operated in the second operating state, on the basis of the input data, is received, and the closure arrangement is activated in a power-driven fashion on the basis of the activation signal.

### BACKGROUND AND SUMMARY OF THE INVENTION

The present invention relates to a method and to a device for the non-mechanical actuation of a closure arrangement, in particular a vehicle door, by way of a mobile terminal, and to a vehicle, in particular a motor vehicle, having such a device.

Doors, for instance vehicle or building doors, are usually opened or closed through the application of force by the user. In this case, the user generally actuates a mechanical device that unlocks or releases the door, for example a door handle or an opening lever, and then pushes the door or then pulls the door. Motor vehicles and buildings in which flaps, such as for instance vehicle doors or garage doors, are opened by way of an electric drive, for example an electric motor, upon instruction from the user are furthermore known. It is known to give this instruction by way of gestures that are able to be recognized by sensors assigned to the flaps.

DE 10 2014 213 940 A1 relates to a method and to a controller for opening a pivoting door through external force, wherein an opening request from the driver to open the door, for example by actuating a control element or a camera-based gesture sensor, is identified, in response to which a door drive automatically opens the closed pivoting door not completely, but rather only to a defined safety position having a certain opening angle.

One object of the invention is to improve the non-mechanical actuation of closure arrangements, in particular to make it more convenient.

This object is achieved by a method and a device for the non-mechanical actuation of a closure arrangement, in particular a vehicle door, by way of a mobile terminal according to the independent claims, and a motor vehicle having such a device. Various embodiments and developments of the invention are the subject matter of the dependent claims.

A first aspect of the invention relates to a method for the non-mechanical actuation of a closure arrangement, in particular a vehicle door, by way of a mobile terminal, having the steps of: (i) detecting the mobile terminal and generating corresponding detection data; (ii) transmitting an activation signal to the detected terminal on the basis of the detection data; (iii) changing from a first operating state of the terminal to a second operating state of the terminal on the basis of the activation signal; (iv) detecting a user input by way of the terminal operated in the second operating state and generating corresponding input data; (v) receiving an actuation signal transmitted by the terminal operated in the second operating state, on the basis of the input data; and (vi) actuating the closure arrangement through external force on the basis of the actuation signal.

Non-mechanical actuation in the context of the invention is in particular actuation that is not performed manually, preferably opening or closure through external force. Non-mechanical actuation is preferably initiation of actuation, in particular indirect actuation, for instance through an electrical signal, for example an actuation signal. In this case, the actuation preferably corresponds not only to unlocking or locking of a closure arrangement, but rather to the clearance of an opening closed by the closure arrangement or closure of this opening by the closure arrangement, for example through pivoting of a door or flap.

A closure arrangement in the context of the invention is suitable in particular for the in particular reversible closure of an opening. A closure arrangement may be for example a flap, a cover, a door or a gate and/or the like. A closure arrangement may also be an engine hood or a sliding window.

A mobile terminal in the context of the invention is in particular an electronic device able to be carried by a user, preferably for communication purposes. A mobile terminal may be for example a smartphone, a headset, VR glasses, a smartwatch and/or the like. The mobile terminal preferably has a processor and is configured so as to allow the processor to execute a computer program.

An operating state in the context of the invention is in particular a configuration of a mobile terminal, in particular with a predefined functionality. The mobile terminal may for example be configured differently in two different operating states, such that it is possible in each case to perform at least partly different functions, for example at least partly different user inputs may be detected by the terminal and/or at least partly different content may be output.

The invention is based in particular on the approach of allowing a user to input a user input for the non-mechanical actuation of a closure arrangement on a mobile terminal when the mobile terminal is detected, for instance by a vehicle or a building. To this end, when the terminal is detected, there is preferably a switch between different operating states of the terminal that each allow different interactions of the terminal with a user. It is in particular possible to switch from a first operating state to a second operating state in which the terminal is configured so as to detect a user input that corresponds to a non-mechanical actuation or on the basis of which actuation of the closure arrangement through external force is initiated.

The first operating state may in this case correspond to normal operation of the terminal in which the user is able for example to use his smartphone or headset for telephone calls or for other purposes. The second operating state preferably corresponds to the terminal being ready to receive commands to actuate the closure arrangement, for example by executing, in contrast to the first operating state, a computer program configured so as to control the closure arrangement on the terminal or authorizing or activating a function for controlling the closure arrangement in this computer program. The user may thus be informed of the possibility of non-mechanical actuation, and possibly also about further steps to be performed that are required or advantageous for the actuation.

By way of example, the smartphone of a user may be detected by his vehicle when the user approaches the vehicle. In this case, corresponding detection data are generated and may be used as a basis for example to establish a data connection between the smartphone and the vehicle. The data connection may be used to transmit an activation signal to the terminal, on the basis of which the terminal switches from the first to the second operating state. Upon the change to the second operating state, a greeting may for example be output to the user by the terminal and a function for the non-mechanical actuation of a vehicle door of the vehicle, for instance a button in an in particular vehicle-specific computer program, may preferably be activated. If the user performs a corresponding, in particular predetermined user input that preferably corresponds to the non-mechanical actuation of the vehicle door, for example pressing the button in the computer program, performing a predefined gesture on or using the smartphone or the smartwatch or giving a voice command via the headset, corresponding input data are preferably generated. The user input is preferably detected using a sensor system of the corresponding terminal, and the input data are generated on the basis of the sensor data generated in the process. The user's intention to actuate the vehicle door may in particular be derived from the input data, and a corresponding actuation signal may be transmitted to the vehicle. After the actuation signal has been received, the vehicle opens the vehicle door, for example by way of an electric motor.

User convenience is thereby increased. By way of example, according to the invention, it is possible to prevent the user from unsuccessfully attempting the non-mechanical actuation, for instance by pressing an electronic vehicle key, at an excessively great distance from the vehicle.

Switching the operating state additionally allows particularly flexible interaction of the user with the terminal in order to actuate the closure arrangement.

Overall, the invention allows improved non-mechanical actuation of a closure arrangement, and in particular makes it possible to increase user convenience.

Preferred embodiments of the invention and developments thereof are described below, each of these developments being able to be combined with one another and with the further aspects of the invention that are described below as desired, unless this is expressly ruled out.

In one preferred embodiment, the method furthermore has the following step: detecting a vehicle operating state of a vehicle, in particular a motor vehicle, that has the closure arrangement to be non-mechanically actuated, and generating corresponding operating data. The activation signal is in this case transmitted preferably on the basis both of the detection data and of the operating data. This allows the terminal, depending on the vehicle operating state, to switch to the second operating state or to a second operating state dependent on the vehicle operating state. In other words, the terminal may switch to a second operating state in which information dependent on the vehicle state is output and/or actuation options dependent on the vehicle operating state are given. The actuation of the closure arrangement, in particular the vehicle door, thereby becomes particularly flexible.

A vehicle operating state in the context of the invention in particular describes a situation, for instance a driving or traffic situation, in which the vehicle is currently situated. A vehicle operating state may for example contain information about driving dynamics variables such as speed, acceleration and/or position of the vehicle, in particular whether or not the vehicle is in operation. As an alternative or in addition, a vehicle operating state may also contain information about the vehicle surroundings, such as for instance weather, other traffic participants and/or the like.

By taking into account the vehicle operating state in the form of the operating data, the interaction of the terminal with the user is therefore able to be adapted depending on the situation, and the user may for example be given various information or options for actuating the closure arrangement. An intelligent behavior of the vehicle is in particular thereby able to be depicted, which assists the user by way of outputting corresponding information via the terminal.

By way of example, it is conceivable for additional information about the vehicle surroundings, in particular the immediate environment of the vehicle, to be output via the terminal and/or for different actuation options to be offered before the beginning or end of the journey. When stopping at a fuel station, possibly depending on the remaining fuel supply in the vehicle, the user may for example be given the option of non-mechanically opening the tank cover of the vehicle. As an alternative or in addition, the user may be informed, prior to leaving the vehicle, that it is raining and that there is an umbrella in the trunk. The user is in this case preferably also given the option of non-mechanically opening the trunk lid.

In a further preferred embodiment, it is checked whether the detected terminal is situated within an outer region around the closure arrangement to be non-mechanically actuated, and a first activation signal is transmitted on the basis of a result of the check, on the basis of which first activation signal the terminal switches to the second operating state. The outer region preferably covers a circle around the closure arrangement of between 2 and 20 m, preferably between 4 and 15 m, in particular between 5 and 10 m. The terminal more preferably switches to a second operating state dependent on the result of the check, wherein corresponding feedback is preferably output to the user via the terminal. The user may thereby be prepared for the non-mechanical actuation of the closure arrangement, in particular informed about the possibility of non-mechanical actuation of the closure arrangement.

By way of example, the terminal may output a haptic, visual and/or acoustic signal when the user enters the outer region with the terminal. A smartphone or a smartwatch may thus for instance vibrate, a headset or a smartphone may output a signal tone and/or a smartphone or VR glasses may display information when the user approaches the vehicle. The user may possibly also be given a route description to the vehicle or building that has the closure arrangement via the terminal, for instance by virtue of a map containing the position of the user and the vehicle or building being displayed or a route being described in acoustic form.

In a further preferred embodiment, it is checked whether the detected terminal is situated within an inner region around the closure arrangement to be non-mechanically actuated, and a second activation signal is transmitted on the basis of a result of the check, on the basis of which second activation signal the terminal switches, in particular from the second operating state, to a third operating state. The inner region preferably covers a circle around the closure arrangement of 2 m or more, preferably of 4 m or more, in particular of 5 m or more. The terminal more preferably switches to a third operating state dependent on the result of the check, wherein corresponding feedback is preferably output to the user via the device. The user is particularly preferably given the option of non-mechanically actuating the closure arrangement only upon entering the inner region. This makes it possible to avoid the user inadvertently actuating the closure arrangement too early and thus for example allowing the undesired entry of a person into the vehicle.

By way of example, on the basis of the result of the check, the user may be informed via the terminal about the opening of a vehicle or building door that is now possible, for instance by virtue of the option “open vehicle door” being shown to the user on his smartphone or in his VR glasses. As an alternative or in addition, the user may be asked, via his smartphone or headset, for instance through a voice output, whether and/or which vehicle door he would like to open. The smartphone or a smartwatch may also possibly be used to display the fact that actuation is possible by performing a gesture.

In a further preferred embodiment, the terminal operated in the second operating state provides a user of the terminal with at least some options for non-mechanically actuating the closure arrangement for selection, in particular on the basis of operating data, in particular on the basis of a result of the check as to whether the terminal is situated within the outer and/or inner region around the closure arrangement to be non-mechanically actuated. The user is thereby able to actuate the closure arrangement in a particularly flexible manner, in particular depending on the situation.

The user may in particular thereby be given situation-dependent options via the terminal. By way of example, the user may be given the option, when he enters the outer region, of his vehicle outputting an optical and/or acoustic signal in order to be able to be found more easily, for instance in a full parking lot. The actuation of the closure arrangement may thereby be prepared. It is likewise conceivable for the user, when he enters the inner region, to be given the options for opening the trunk lid, the driver's door and/or the passenger door.

In a further preferred embodiment, the mobile terminal provides the user with the options for selection on the basis of user data that are generated by way of machine learning from previously generated input data. In other words, the second operating state may preferably be adapted on the basis of the user data. The user behavior is thereby able to be evaluated in order to increase user convenience.

By way of example, previous behavior of the user may be used to learn which of a plurality of vehicle doors should be opened automatically when the user approaches the vehicle. If the user has already opened the driver's door multiple times in the past, the user may be given the option, when changing to the second or third operating state, to automatically open the driver's door when entering the inner region in the future, that is to say without any further input from the user being necessary. If the user selects this option, that is to say in the case of a corresponding user input, the second or third operating state may be configured accordingly such that the driver's door is opened automatically when entering the inner region.

In a further preferred embodiment, a motion vector of a user of the terminal is determined when the mobile terminal is detected. A motion vector in the context of the invention is in this case in particular a trajectory of the user with which said user approaches the closure arrangement or moves away from the closure arrangement. The motion vector is preferably used to estimate the closure arrangement, in particular the vehicle door, to be non-mechanically opened. The user may thereby be offered corresponding options for opening the closure arrangement, as a result of which the actuation becomes particularly convenient and flexible.

By way of example, a position of the terminal may be determined multiple times by way of triangulation when approaching the vehicle in order to derive the motion vector. By extrapolating the motion vector, the vehicle door expected to be opened is preferably able to be derived and the option for opening this vehicle door is able to be given.

A second aspect of the invention relates to a device for the non-mechanical actuation of a closure arrangement, in particular a vehicle door, by way of a mobile terminal. The device has a detection apparatus that is configured so as to detect the mobile terminal and to generate corresponding detection data, and a communication apparatus that is configured so as to transmit an activation signal to the detected terminal on the basis of the detection data. The activation signal is preferably suitable for changing the terminal from a first operating state to a second operating state. The communication apparatus is additionally configured so as to receive an actuation signal transmitted by the terminal operated in the second operating state, on the basis of detection data, wherein the detection data are generated by the terminal operated in the second operating state when a user input is detected by way of the terminal. An actuation apparatus is additionally configured so as to actuate the closure arrangement through external force on the basis of the actuation signal.

A third aspect of the invention relates to a vehicle, in particular a motor vehicle, that has a device according to the second aspect of the invention.

The features and advantages described with regard to the first aspect of the invention and the advantageous embodiments thereof also apply, at least where this makes technical sense, to the second and third aspect of the invention and the advantageous embodiments thereof, and vice versa.

Further features, advantages and application possibilities of the invention become apparent from the following description in connection with the figures.

### BRIEF DESCRIPTION OF THE DRAWINGS

FIG. 1 shows a preferred exemplary embodiment of a device for the non-mechanical actuation of a closure arrangement.

FIG. 2 shows a preferred exemplary embodiment of a method for the non-mechanical actuation of a closure arrangement.

### DETAILED DESCRIPTION OF THE DRAWINGS

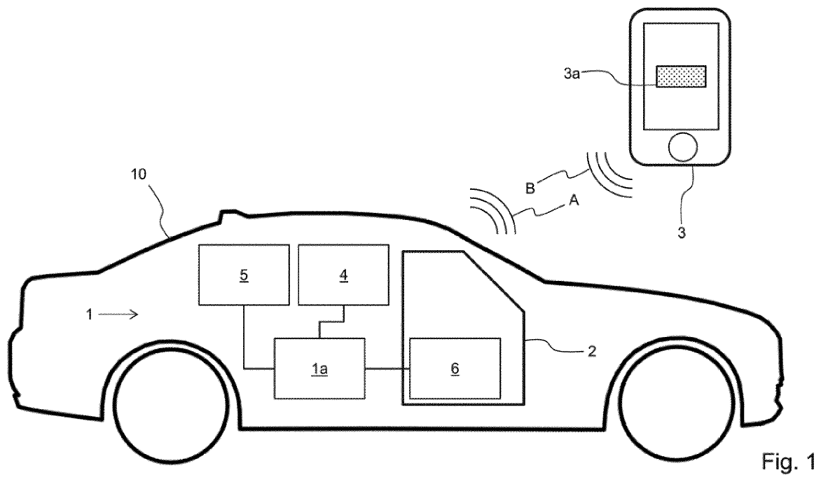

FIG. 1 shows a preferred exemplary embodiment of a device 1 for the non-mechanical actuation of a closure arrangement 2 by way of a mobile terminal 3. In the example that is shown, a vehicle 10 is equipped with the device 1 and the closure device 2 is in the form of a vehicle door and the terminal 3 is in the form of a smartphone.

The device 1 has a detection apparatus 4 that is configured so as to detect the terminal 3 and to generate corresponding detection data. The terminal 3 may for example be coupled to the vehicle 10, for instance via Bluetooth, WLAN or another air interface. In this case, an identifier of the terminal 3, such as for instance an IMSI (International Mobile Subscriber Identity) or IMEI (International Mobile Equipment Identity), is preferably transmitted to the vehicle 10 or the device 1, on the basis of which the terminal 3 is able to be identified, preferably uniquely. Information about a first operating state of the terminal 3 in which the terminal 3 is currently being operated is in this case further preferably also transmitted. Information about the identifier and/or the first operating state may be contained in the detection data. By virtue of the detection data, the vehicle 10 or the device 1 is preferably given the ability to transmit control commands, in particular an activation signal A, to the terminal 3, in particular to control the terminal 3.

To this end, the device 1 has for example a communication apparatus 5 that is configured so as to transmit the activation signal A, generated on the basis of the detection data, to the terminal 3. The communication apparatus 5 may be connected to a controller 1a or have a controller 1a that is configured so as to generate the activation signal A or the control commands corresponding thereto.

The activation signal A is preferably received by the terminal 3, which then switches from the first operating state to a second operating state in which a user input from a user of the terminal 3 is able to be detected. By way of example, on the basis of the received activation signal A, a computer program may be booted that displays a button 3a to the user via the terminal, the actuation of which button brings about the opening or closure of the vehicle door. As an alternative or in addition, the terminal 3 may output information, in a second operating state, that the vehicle door is able to be opened or closed by way of a predefined gesture to be performed by the user with the terminal 3.

The configuration of the terminal 3, in particular the configuration of the second operating state, is in this case preferably dependent on the activation signal A or the detection data. This means that the user may be given various information and/or options for actuating the closure arrangement 2 via the terminal 3 depending on the activation signal A. It is conceivable for example for the user to be greeted via the terminal 3 upon initial detection of the terminal 3 and to be given the option of opening the driver's door, the passenger door and/or the trunk lid. If the terminal 3 has already been detected multiple times and if the user has already predominantly selected a certain option, for instance opening the driver's door, the user may be asked whether the driver's door should always be opened in the future when the terminal 3 is detected.

When the activation signal A is transmitted, a vehicle operating state, preferably detected by the controller 1a, of the vehicle 10 may also be taken into account, such that the user's options for actuating the closure arrangement 2 may depend on the situation. Before the beginning of the journey, the option for opening the vehicle door may for example be given when the user is moving in the circle around the vehicle before entering the vehicle. Following the end of the journey, on the other hand, the option for closing the vehicle door may be given when the user is moving in the circle around the vehicle after exiting the vehicle.

If the user performs the corresponding user input, that is to say if he presses the button 3a that is shown or performs the predefined gesture, preferably corresponding detection data are generated by the terminal 3 and used as a basis for transmitting an actuation signal B to the vehicle 10 or the communication apparatus 5. In this case, the actuation signal B preferably identifies the option selected by the user. The actuation signal B may be received by the communication apparatus 5, whereupon an actuation apparatus 6, for instance an electric motor, opens the vehicle door through external force.

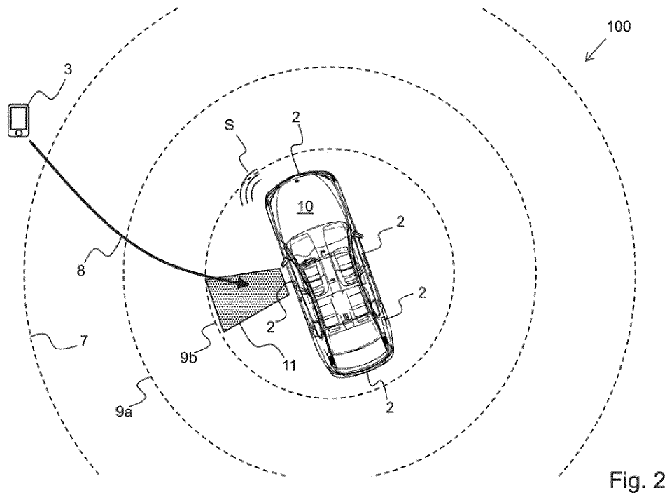

FIG. 2 shows a preferred exemplary embodiment of a method 100 for the non-mechanical actuation of a closure arrangement 2 by way of a mobile terminal 3. In the example that is shown, various vehicle doors, a trunk lid, an engine hood and/or a tank cover of a vehicle 10 may be actuated non-mechanically by way of the terminal 3, that is to say pivoting of these closure arrangements 2 through external force may be initiated.

The terminal 3 is preferably first of all detected, for example when a user with the terminal 3 enters into a detection region 7 around the vehicle 10. The spatial extent of the detection region 7 may in this case be predefined for example by the range of a radio connection between the terminal 3 and the vehicle 10.

When the terminal 3 is detected, detection data are preferably generated, on the basis of which data, in particular control commands, are able to be transmitted between the terminal 3 and the vehicle 10 and/or further information is able to be derived. The detection data may for example be used to determine a motion vector 8 of the user that depicts the user approaching the vehicle 10 and by way of which it is possible to conclude as to the vehicle door expected to be actuated.

The detection data may also be used to check whether the terminal 3 is situated within an outer region 9a around the vehicle 10, in particular around the vehicle door to be actuated, preferably determined on the basis of the motion vector 8. If the check reveals that the terminal 3 is situated within the outer region 9a, for example at a distance of 20 m or less, preferably 15 m or less, in particular 10 m or less, a first activation signal is preferably transmitted to the terminal 3, on the basis of which the terminal 3 is able to switch from a first operating state to a second operating state.

Following the change to the second operating state, the user is preferably greeted via the mobile terminal 3 and informed about various options as to how he is able to proceed with actuating the vehicle door. By way of example, the terminal 3 may be configured, in the second operating state, such that the user, through a user input on the terminal 3, is able to trigger outputting of an in particular visual and/or acoustic signal S by the vehicle 10, for instance by flashing a direction indicator or actuating a horn, in order to be able to find the vehicle 10, and thus the closure arrangement 2 to be actuated, more easily. As an alternative or in addition, the terminal 3 may be configured, in the second operating state, such that a route description to the vehicle 10 or a distance from the vehicle 10 is able to be output to the user via the terminal 3, for instance in the form of a map display, a radar image or a directional arrow on a smartphone screen or a smartwatch screen, visual highlighting of the vehicle in virtual or augmented reality displayed by way of VR glasses, a voice output through a headset and/or a signal tone that becomes shorter as a function of the distance from the vehicle 10 via a headset or a smartwatch.

By using the abovementioned functions, possibly also through a haptic, visual or acoustic signal that is output as an alternative or in addition by the terminal 3, the user is able to be informed that he is able to non-mechanically actuate, that is to say open or close through external force, a vehicle door by way of the terminal when he further approaches the vehicle 10, for instance through vibration of the smartphone or the smartwatch, through a corresponding display on the smartphone, the smartwatch or in the VR glasses or through a corresponding signal tone output via the smartphone, the smartwatch or the headset.

The detection data may further preferably also be used to check whether the terminal 3 is situated within an inner region 9b around the vehicle 10, in particular around the vehicle door to be actuated, preferably determined on the basis of the motion vector 8. If the check reveals that the terminal 3 is situated within the inner region 9b, for example at a distance of 10 m or less, preferably 5 m or less, in particular 2 m or less, a second activation signal is preferably transmitted to the terminal 3, on the basis of which the terminal 3 is able to switch from the second operating state to a third operating state.

Following the switch to the third operating state, the user is preferably given at least one option, via the mobile terminal 3, of actuating a closure arrangement 2 through external force. By way of example, the terminal 3 may be configured, in the second operating state, such that the user is able to open or close one of the vehicle doors, the trunk lid, the engine hood and/or the tank cover through a user input on the terminal 3.

These various options may be presented to the user for example visually or acoustically. The user may select the desired option haptically or acoustically, that is to say for example by touching a corresponding button on a display of the terminal 3, by performing a corresponding gesture or through a voice input. The user situated within the inner region 9b may thus open a certain one of the vehicle doors, in particular the vehicle door situated directly in front of him, through a corresponding user input and, after he has got into the vehicle, close the opened vehicle door through a further corresponding user input.

If the terminal 3 is situated in the outer and/or inner region 9a, 9b, the vehicle door to be actuated, in particular the one assumed according to the motion vector 8, may also be marked, for example through a light carpet 11 projected onto the ground by the vehicle 10. The marking may advantageously be taken into account via the terminal 3 in the third operating state, for instance by virtue of the user being given the option of opening the vehicle door marked by the light carpet 11.

The detection data may possibly also contain information about the user and/or the user surroundings, on the basis of which the activation signal is transmitted or the terminal switches to the first or second operating state. On the basis of the detection data, possibly situation-dependent information and/or options for actuating the closure arrangement 2 may thereby be given.

By way of example, it may become apparent from the detection data that the user is carrying a piece of luggage. This may be the case when the terminal 3 is in the form of an RFID tag that is fastened to the piece of luggage or is part of the piece of luggage. A terminal 3 in the form of a smartphone could likewise be coupled to an RFID tag of the piece of luggage and transmit corresponding information when linked to the vehicle 10. In the second or third operating state, the user may accordingly be asked, via the terminal 3, whether the piece of luggage should be placed in the trunk of the vehicle and whether the trunk lid should accordingly be opened.

The first activation signal and/or the second activation signal is preferably transmitted to the terminal 3 on the basis of operating data that characterize a vehicle operating state of the vehicle 10, wherein the terminal 3 accordingly switches to the first or second operating state depending on the operating data or the vehicle operating state. The terminal 3 may in this case in particular accordingly switch to the first or second operating state dependent on the vehicle operating state. The user is thereby able to be given situation-dependent information and/or options for actuating the closure arrangement 2.

If the vehicle operating state for example contains information about the vehicle surroundings, for instance about the distances between the vehicle 10 and further vehicles parked in the vicinity, the user may be offered to actuate only those vehicle doors for which opening through external force would not damage any of the surrounding vehicles.

Even though the method according to the invention in connection with FIG. 2 is illustrated only in connection with the user or the terminal 3 approaching the vehicle 10, it is clear to a person skilled in the art that the method may also be applied when leaving the vehicle 10, that is to say when the user or the terminal 3 moves away from the vehicle 10.

When the vehicle 10 ends its journey, this being indicated for example by switching off the engine, the user, still sitting in the vehicle and thereby situated in the inner region 9b, may initiate opening of a driver's door through a corresponding user input via the terminal 3 operated in the third operating mode and, after getting out, may also initiate closure of the opened vehicle door. If the user leaves the inner region 9b or enters the outer region 9a, the user may be reminded of objects that he has left in the vehicle via the terminal 3 and/or informed that the vehicle has not yet been locked, and the user may be given options for locking some or all of the closure arrangements 2 of the vehicle 10. When leaving the outer region 9a, the user is preferably bid farewell by the terminal 3. If the user has input a destination via a navigation system of the vehicle 10 and has parked in the vicinity of the destination, a route description from the parked vehicle 10 to the destination may also be output to the user on the terminal 3.

### LIST OF REFERENCE SIGNS

1 device

1a controller

2 closure arrangement

3 terminal

3a button

4 detection apparatus

5 communication apparatus

6 actuation apparatus

7 detection region

8 motion vector

9a outer region

9b inner region

10 vehicle

11 light carpet

100 method

A activation signal

B actuation signal

S signal

1-9. (canceled)

10. A method for non-mechanical actuation of a closure arrangement by way of a mobile terminal, comprising:
detecting the mobile terminal and generating corresponding detection data;
transmitting an activation signal to the detected terminal on the basis of the detection data;
changing from a first operating state of the terminal to a second operating state of the terminal on the basis of the activation signal;
detecting a user input by way of the terminal operated in the second operating state and generating corresponding input data;
receiving an actuation signal transmitted by the terminal operated in the second operating state, on the basis of the input data; and
actuating the closure arrangement through external force on the basis of the actuation signal.

11. The method according to claim 11, further comprising:
detecting a vehicle operating state of a vehicle having the closure arrangement to be non-mechanically actuated, and generating corresponding operating data,
wherein the activation signal is transmitted on the basis both of the detection data and of the operating data.

12. The method according to claim 11, wherein
the method checks whether the detected terminal is situated within an outer region around the closure arrangement to be non-mechanically actuated, and
a first activation signal is transmitted on the basis of a result of the check, on the basis of which first activation signal the terminal switches to the second operating state.

13. The method according to claim 12, wherein
the method checks whether the detected terminal is situated within an inner region around the closure arrangement to be non-mechanically actuated, and
a second activation signal is transmitted on the basis of a result of the check, on the basis of which second activation signal the terminal switches from the second operating state to a third operating state.

14. The method according to claim 13, wherein
the terminal operated in the second or third operating state provides a user of the terminal with options for non-mechanically actuating the closure arrangement for selection.

15. The method according to claim 14, wherein
the options are based on a result of the check as to whether the terminal is situated within the outer and/or inner region around the closure arrangement to be non-mechanically actuated.

16. The method according to claim 14, wherein
the mobile terminal provides the user with the options for selection on the basis of user data that are generated by way of machine learning from previously generated input data.

17. The method according to claim 10, wherein
a motion vector of a user of the terminal is determined when the mobile terminal is detected.

18. The method according to claim 10, wherein
the method checks whether the detected terminal is situated within an outer region around the closure arrangement to be non-mechanically actuated, and
a first activation signal is transmitted on the basis of a result of the check, on the basis of which first activation signal the terminal switches to the second operating state.

19. The method according to claim 10, wherein
the method checks whether the detected terminal is situated within an inner region around the closure arrangement to be non-mechanically actuated, and
a second activation signal is transmitted on the basis of a result of the check, on the basis of which second activation signal the terminal switches from the second operating state to a third operating state.

20. The method according to claim 10, wherein
the closure arrangement is a vehicle door.

21. A device for non-mechanical actuation of a closure arrangement by way of a mobile terminal, comprising:
a detection apparatus that is configured so as to detect the mobile terminal and to generate corresponding detection data;
a communication apparatus that is configured so as to transmit an activation signal to the detected terminal on the basis of the detection data, on the basis of which activation signal the terminal is able to be changed from a first operating state to a second operating state, and to receive an actuation signal transmitted by the terminal operated in the second operating state, on the basis of detection data that are generated by the terminal operated in the second operating state when a user input is detected; and
an actuation apparatus that is configured so as to actuate the closure arrangement through external force on the basis of the actuation signal.

22. The device according to claim 21, wherein
the closure arrangement is a vehicle door.

23. A vehicle comprising a device according to claim 21 for non-mechanical actuation of a vehicle door.
